(19) United States
(12) Patent Application Publication
(10) Pub. No.: US 2019/0263153 A1
(43) Pub. Date: Aug. 29, 2019

(54) PRINTING APPARATUS FOR WEB

(71) Applicant: RISO KAGAKU CORPORATION, Tokyo (JP)

(72) Inventors: Mamoru WAKABAYASHI, Ibaraki (JP); Takashi EBISAWA, Ibaraki (JP)

(73) Assignee: RISO KAGAKU CORPORATION, Tokyo (JP)

(21) Appl. No.: 16/279,307

(22) Filed: Feb. 19, 2019

(30) Foreign Application Priority Data
Feb. 28, 2018 (JP) 2018-035174
Feb. 28, 2018 (JP) 2018-035191

(51) Int. Cl. B41J 13/00

(52) U.S. Cl. CPC B41J 13/0009

(57) ABSTRACT

A controller controls first print timings in respective first print mechanisms of a first printer based on a first pulse signal outputted from a first encoder and controls second print timings in respective second print mechanisms of a second printer based on a second pulse signal outputted from a second encoder.

### CROSS REFERENCE TO RELATED APPLICATION

This application is based upon and claims the benefit of priority from the prior Japanese Patent Application Nos. 2018-035174 filed on Feb. 28, 2018 and 2018-035191 filed on Feb. 28, 2018, the entire contents of which are incorporated herein by reference.

### BACKGROUND

### 1. TECHNICAL FIELD

The disclosure relates to a printing apparatus which performs printing on a web.

### 2. RELATED ART

There is known a printing apparatus which prints an image on a long web being a print medium by ejecting inks from inkjet heads to the web while conveying it.

Japanese Patent Application Publication No. 2003-63072 proposes a printing apparatus which includes a printer for a front surface of a web and a printer for a back surface arranged. downstream of the printer for the front surface in a conveyance direction of the web and which can perform printing on both surfaces of the web.

As a printing apparatus capable of performing printing on both surfaces as described above, there is an apparatus in which the printer for the front surface and the printer for the back surface each include inkjet heads which eject inks of different colors. The inkjet heads in each printer are aligned in the conveyance direction of the web.

In such a printing apparatus, an ejection timing of the ink in each inkjet head is controlled based on an output pulse signal of an encoder connected to a roller which rotates in synchronization with the web being conveyed.

### SUMMARY

In the ejection timing control as described above, accuracy of an ink landing position decreases as the distance from the encoder to the inkjet head increases, due to an effect of stretching and shrinking of the web and the like. Accordingly, for example, when the encoder is arranged near and upstream of the printer for the front surface, misalignment of the ink landing positions may occur between the inkjet heads in the printer for the back surface far from the encoder due to the decrease in the ink landing position accuracy. Specifically, in some cases, color misregistration occurs in the image printed on the back surface and print image quality decreases.

The disclosure is directed to a printing apparatus which can reduce a decrease in image quality.

A printing apparatus in accordance with some embodiments includes: a first printer including first print mechanisms aligned in a conveyance direction of a web, the first printer

configured to print a first image on a first surface of the web being conveyed by using the first print mechanisms; a second printer including second print mechanisms aligned in the conveyance direction, the second printer configured to print a second image on a second surface of the web being conveyed by using the second printmechanisms; a first roller configured to rotate in synchronization with the web being conveyed; a second roller configured to rotate in synchronization with the web being conveyed; a first encoder configured to output a first pulse signal de ending on a rotation angle of the first roller; a second encoder configured to output a second pulse signal depending on a rotation angle of the second roller; and a controller configured to control first print timings in the respective first print mechanisms of the first printer based on the first pulse signal outputted from the first encoder and control second print timings in the respective second print mechanisms of the second printer based on the second pulse signal outputted from the second encoder.

According to the aforementioned configuration, misalignment in the ink landing positions between the first printer and the second printer can be suppressed. A decrease in print image quality is thereby suppressed.

The controller may be configured to adjust at least one of a first print length on the first surface or a second print length on the second surface in the conveyance direction by using difference information indicating a difference between a first outer circumferential length of the first roller and a second outer circumferential length of the second roller such that a difference between the first print length and the second print length is reduced.

According to the aforementioned configuration, it is possible to reduce misalignment between images printed on the front and back surfaces of the web W while suppressing the decrease in the print image quality.

The second printer may be arranged downstream of the first printer in the conveyance direction, the first roller may be arranged upstream of the second printer in the conveyance direction, the second roller may be arranged downstream of the first printer and downstream of the first roller in the conveyance direction, the first encoder may be installed in the first roller, and the second encoder may be installed in the second roller. The controller may be configured to: control the first print timings based on the first pulse signal having been outputted since a control start timing; and control the second print timings based on the second pulse signal having been outputted since the control start timing.

According to the aforementioned configuration, it is possible to reduce the decrease in the print image quality while preventing the configuration of the printing apparatus from becoming complex.

### BRIEF DESCRIPTION OF DRAWINGS

FIG. 1 is a schematic configuration view of a print system including a printing apparatus according a first embodiment.

FIG. 2 is a control block diagram of the print system illustrated in FIG. 1.

FIG. 3 is a view explaining misalignment between images printed on a front surface and a back surface of a web.

FIG. 4 is a flowchart for explaining an adjustment table generating operation in the first embodiment.

FIG. 5 is a view for explaining a method of setting adjustment flags in the adjustment table generating operation.

FIG. 6 is a view illustrating an example of an adjustment table.

FIG. 7A is a view explaining a method of adjusting a print length.

FIG. 7B is a view explaining the method of adjusting the print length.

FIG. 8 is a flowchart of processing of adjusting the print length in a second embodiment.

FIG. 9 is a view explaining how output pulses of encoders are counted in the processing of adjusting the print length in the second embodiment.

FIG. 10 is a schematic configuration view of a print system including a printing apparatus according a third embodiment.

FIG. 11 is a control block diagram of the print system illustrated in FIG. 10.

FIG. 12 is a block diagram illustrating a configuration of a printing apparatus controller included in the printing apparatus of the print system illustrated in FIG. 10.

FIG. 13 is a view explaining a holding angle of the web on a guide roller.

FIG. 14 is a view explaining ink ejection timing control.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

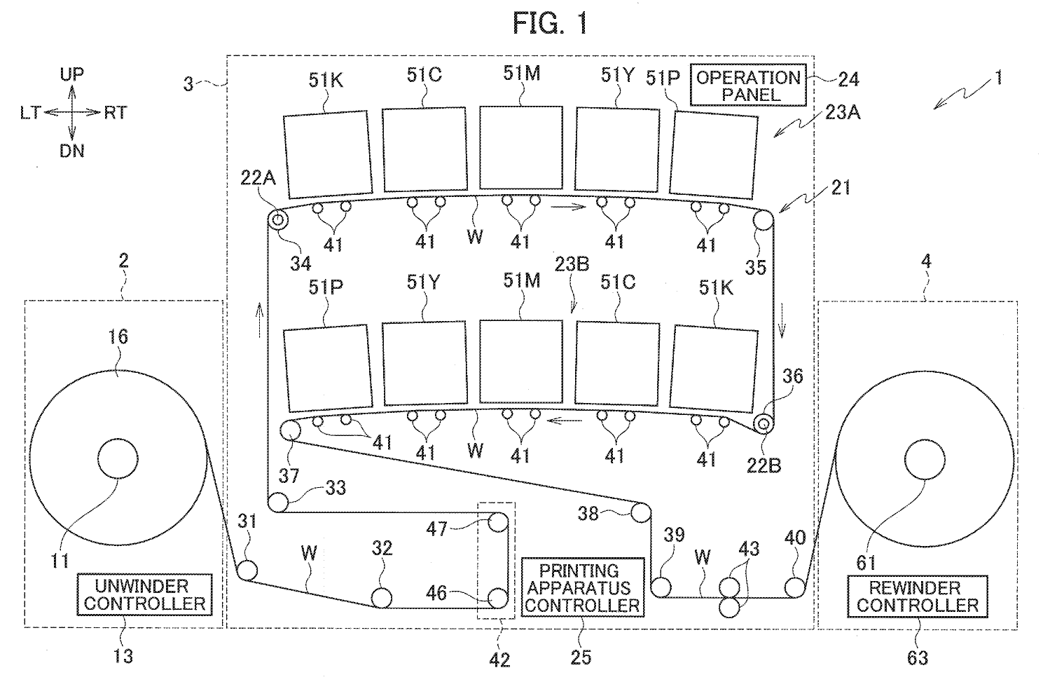

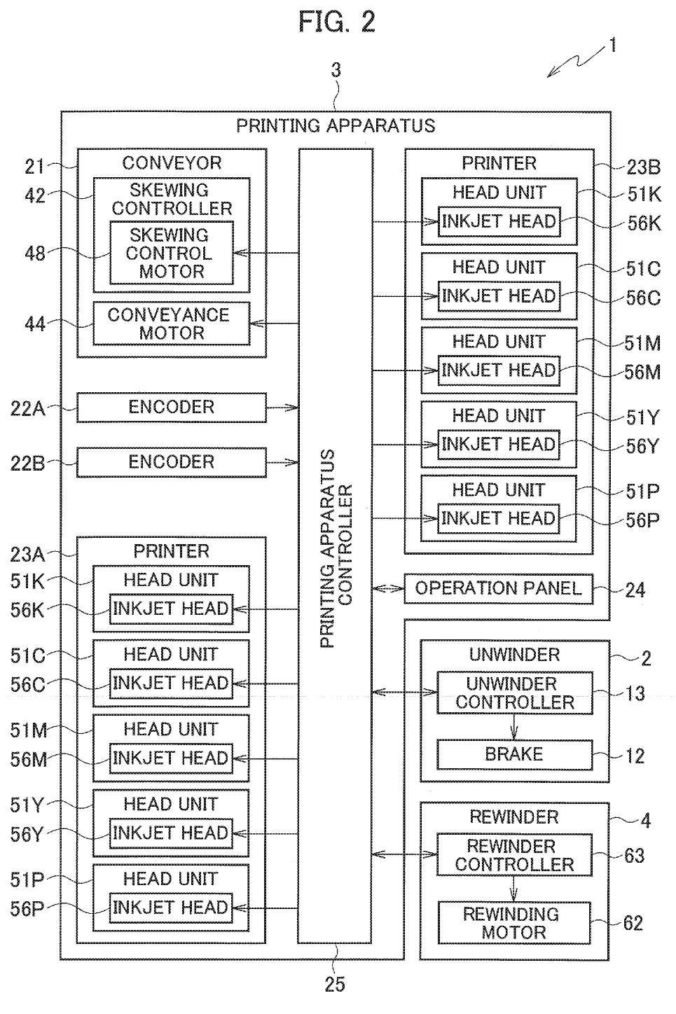

A first embodiment of the present invention is described below with reference to the drawings. FIG. 1 is a schematic configuration view of a print system 1 including a printing apparatus 3 according the first embodiment. FIG. 2 is a control block diagram of the print system 1 illustrated in FIG. 1. In the following description, a direction orthogonal to the sheet surface of FIG. 1 is referred to as front-rear direction. Moreover, up, down, left, and right in the sheet surface of FIG. 1 are referred to as directions of up, down, left, and right. In FIG. 1, the directions of right, left, up, and down are denoted by RT, LT, UP, and DN, respectively.

As illustrated in FIGS. 1 and 2, the print system 1 according to the first embodiment includes an unwinder 2, the printing apparatus 3, and a rewinder 4.

The unwinder 2 unwinds a web W being a long print medium made of film, paper, or the like to the printing apparatus 3. The unwinder 2 includes a web roll support shaft 11, a brake 12, and an unwinder controller 13.

The web roll support shaft 11 rotatably supports a web roll 16. The web roll 16 is the web W wound into a roll.

The brake 12 applies brake to the web roll support shaft 11. Tension is thereby applied to the web W between the web roll 16 and a pair of conveyance rollers 43 of the printing apparatus 3 to be described later.

The unwinder controller 13 controls the brake 12. The unwinder controller 13 includes a CPU, a memory, a hard disk drive, and the like.

The printing apparatus 3 prints images on the web W while conveying the web W unwound from the web roll 16. The printing apparatus 3 includes a conveyor 21, encoders 22A, 22B (each of which is a first or second encoder), printers 23A, 23B (each of which is a first or second printer), an operation panel 24, and a printing apparatus controller (controller) 25. Note that members such as the encoders 22A, 22B may be collectively referred to by omitting the alphabets attached to the reference numeral.

The conveyor 21 conveys the web W unwound from the web roll 16 to the rewinder 4. The conveyor 21 includes guide rollers 31 to 40, 20 under-head rollers 41, a skewing controller 42, the pair of conveyance rollers 43, and a conveyance motor 44.

The guide rollers 31 to 40 guide the web W conveyed in the printing apparatus 3. The guide rollers 31 to 40 rotate by following the web W being conveyed. The guide rollers 31 to 40, the under-head rollers 41, the conveyance rollers 43, and skewing control rollers 46, 47 of the skewing controller 42 to be described later form a conveyance route of the web W in the conveyor 21.

The guide rollers 31, 32 guide the web W between the unwinder 2 and the skewing controller 42. The guide roller 31 is arranged in a left end portion of a lower portion of the printing apparatus 3. The guide roller 32 is arranged between the guide roller 31 and the skewing control roller 46 of the skewing controller 42 to be described later.

The guide rollers 33 to 39 guide the web W between the skewing controller 42 and the pair of conveyance rollers 43. The guide roller 33 is arranged slightly above and on the left side of the skewing control roller 47 in the skewing controller 42 to be described later. The guide roller 34 is arranged above the guide roller 33. The guide roller 35 is arranged on the right side of the guide roller 34 at substantially the same height as the guide roller 34. The guide roller 36 is arranged below the guide roller 35 and above the guide roller 33. The guide roller 37 is arranged on the left side of the guide roller 36, near and on the right side of the web W between the guide rollers 33, 34, at substantially the same height as the guide roller 36. The guide roller 38 is arranged on the lower right side of the guide roller 37. The guide roller 39 is arranged below and slightly on the right side of the guide roller 38.

The guide roller 40 guides the web W between the pair of conveyance rollers 43 and the rewinder 4. The guide roller 40 is arranged in a right end portion of a lower portion of the printing apparatus 3.

The under-head rollers 41 support the web W under head units 51 to be described later in an area between the guide rollers 34, 35 and an area between the guide rollers 36, 37. Ten under-head rollers 41 are arranged in each of the area between the guide rollers 34, 35 and the area between the guide rollers 36, 37. Moreover, two under-head rollers 41 are arranged just below each head unit 51. The under-head rollers 41 rotate by following the web W being conveyed.

The skewing controller 42 corrects skewing which is fluctuation in the position of the web W in a width direction (front-rear direction) orthogonal to the conveyance direction of the web W. The skewing controller 42 includes the skewing control rollers 46, 47 and a skewing control motor 48.

The skewing control rollers 46, 47 are rollers for guiding the web W and correcting the skewing of the web W. The skewing control rollers 46, 47 rotate by following the web W being conveyed. The skewing control rollers 46, 47 move the web W in the width direction by being turned to tilt with respect to the width direction of the web W as viewed in the left-right direction and thereby correct the skewing. The skewing control roller 46 is arranged on the right side of the guide roller 32. The skewing control roller 47 is arranged above the skewing control roller 46.

The skewing control motor 48 turns the skewing control rollers 46, 47 about rotation axes parallel to the left-right direction.

The pair of conveyance rollers 43 conveys the web W toward the rewinder 4 while nipping the web W. The pair of conveyance rollers 43 is arranged between the guide rollers 39, 40.

The conveyance motor 44 rotationally drives the conveyance rollers 43.

An encoder 22A is installed in the guide roller 34 (first or second roller) and outputs a pulse signal depending on a rotation angle of the guide roller 34 which rotates by following (rotates in synchronization with) the web W being conveyed. An encoder 22B is installed in the guide roller 36 (first or second roller) and outputs a pulse signal depending on a rotation angle of the guide roller 36 which rotates by following (rotates in synchronization with) the web W being conveyed.

The printer 23A prints images on a front surface (first or second surface) of the web W. The printer 23A is arranged near and above the web W between the guide rollers 34, 35. The printer 23A includes head units 51K, 51C, 51M, 51Y, 51P.

The head units 51K, 51C, 51M, 51Y, 51P include inkjet heads (print mechanisms) 56K, 56C, 56M, 56Y, 56P, respectively. The head units 51K, 51C, 51M, 51Y, 51P are aligned in a sub-scanning direction (left-right direction) which is the conveyance direction of the web W. Accordingly, the inkjet heads 56K, 56C, 56M, 56Y, 56P are also aligned in the sub-scanning direction.

The inkjet heads 56K, 56C, 56M, 56Y, 56P print images by ejecting inks of black (K), cyan (C), magenta (M), yellow (Y), and an extra ink color, respectively, to the web W. Red, light cyan, or the like is used as the extra ink color.

The inkjet heads 56 each include multiple nozzles (not illustrated) which are arranged in the main scanning direction (front-rear direction) and which are opened on an ink ejection surface facing the web W and eject the inks from the nozzles.

The printer 23B prints images on a back surface (second or first surface) of the web W. The printer 23B is arranged near and above the web W between the guide rollers 36, 37. In other words, the printer 23B is arranged downstream of the printer 23A in the conveyance direction of the web W. The printer 23B includes head units 51K, 51C, 51M, 51Y, 51P, like the printer 23A.

The configuration of the printer 23B is right-left reversed to the configuration of the printer 23A. The configuration of the printer 23B is the same as that of the printer 23A except for being right-left reversed.

The operation panel 24 displays various input screens and the like and receives input operations performed by the user. The operation panel 24 includes a display unit (not illustrated) including a liquid crystal display panel and the like and an input unit (not illustrated) including various operation keys, a touch panel, and the like.

The printing apparatus controller 25 controls operations of the units in the printing apparatus 3. The printing apparatus controller 25 includes a CPU, a memory, a hard disk drive, a Field Programmable Gate Array (FPGA), and the like.

In printing, the printing apparatus controller 25 drives the inkjet heads 56 of the printers 23A, 23B to print images on the web W while driving the conveyance rollers 43 to convey the web W.

In this case, the printing apparatus controller 25 controls ink ejection timings (print timings) in the inkjet heads 56 of the printer 23A based on an output pulse signal of the encoder 22A. Moreover, the printing apparatus controller 25 controls ink ejection timings in the inkjet heads 56 of the printer 23B based on an output pulse signal of the encoder 22B.

Furthermore, the printing apparatus controller 25 adjusts a print length in at least one of the printers 23A, 23B by using difference information such that a difference in a print length between the front and the back surfaces in the conveyance direction of the web W is reduced, the difference information indicating a difference in an outer circumferential length between the guide roller 34 in which the encoder 22A is installed and the guide roller 36 in which the encoder 22B is installed. In this description, the print length is a length of a print region of an image in the conveyance direction of the web W.

Specifically, the printing apparatus controller 25 uses a pulse difference Db per page which is a difference value between the numbers of output pulses of the encoders 22A, 22B per page and which is to be described later, as the difference information indicating the difference in the outer circumferential length between the guide rollers 34, 36. The printing apparatus controller 25 generates an adjustment table 71 to be described later by using the pulse difference Db per page. In the printing, the printing apparatus controller 25 adjusts the print length in at least one of the printers 23A, 23B page by page by referring to the adjustment table 71.

The rewinder 4 rewinds the web K subjected to printing in the printing apparatus 3. The rewinder 4 includes a rewinding shaft 61, a rewinding motor 62, and a rewinder controller 63.

The rewinding shaft 61 rewinds and holds the web W.

The rewinding motor 62 rotates the rewinding shaft 61 clockwise in FIG. 1. Rotation of the rewinding shaft 61 causes the web W to be rewound on the rewinding shaft 61.

The rewinder controller 63 controls drive of the rewinding motor 62. The rewinder controller 63 includes a CPU, a memory, a hard disk drive, and the like.

Next, an adjustment table generating operation in the print system 1 is described.

The adjustment table generating operation is an operation of generating the adjustment table 71 used to adjust the print length on the web W.

The adjustment of the print length using the adjustment table 71 is performed to suppress misalignment between images printed on the front and the back surfaces of the web W which is caused by a difference in the outer circumferential length between the guide rollers 34, 36 due to a mechanical tolerance.

The guide rollers 34, 36 are rollers with the same diameter. However, the outer circumferential length of the guide roller 34 is different from that of the guide roller 36 due to the mechanical tolerance. When the outer circumferential length of the guide roller 34 is different from that of the guide roller 36, the conveyance amount of the web W with respect to the number of output pulses of the encoder 22A corresponding to the guide roller 34 is different from that of the encoder 22B corresponding to the guide roller 36. A print length of an image printed on the front surface of the web K by the printer 23A based on the output pulse signal of the encoder 22A is thereby different from a print length of an image printed on the back surface of the web W by the printer 23B based on the output pulse signal of the encoder 22B. Then, as the printing proceeds, an amount of misalignment between the images printed on the front and back surfaces of the web W gradually increases.

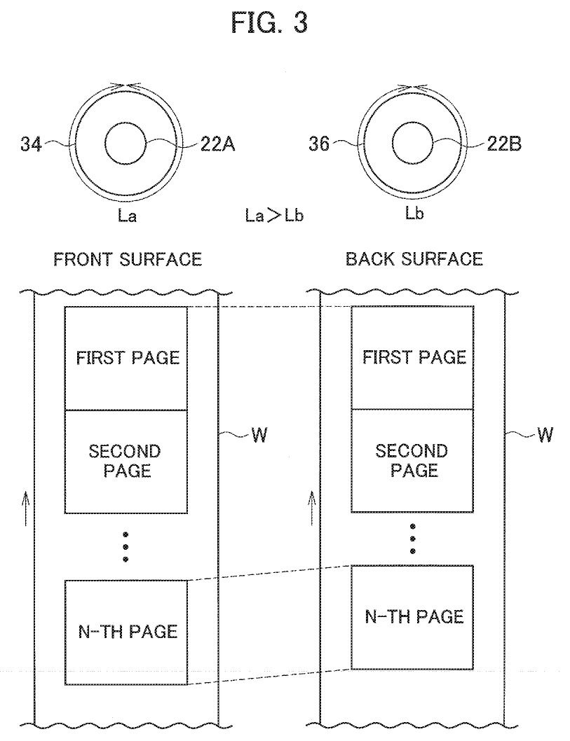

For example, when the outer circumference La of the guide roller 34 is larger than the outer circumference Lb of the guide roller 36, as illustrated in FIG. 3, the print length on the front surface is longer than that on the back surface and pages on the front surface are shifted upstream relative to pages on the back surface corresponding to the pages on the front surface.

The adjustment table 71 is used to adjust the print length to suppress such misalignment between the images printed on the front and back surfaces of the web W.

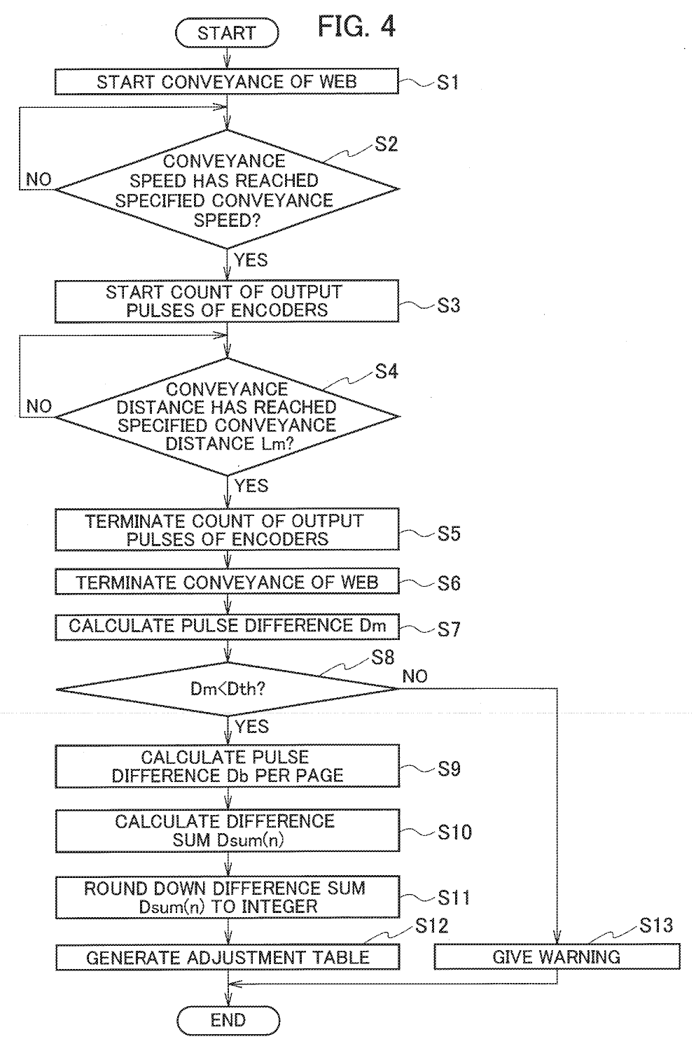

The adjustment table generating operation is performed in such cases where the printing apparatus 3 is completed and the guide rollers 34, 36 are replaced. FIG. 4 is a flowchart for explaining the adjustment table generating operation.

In step 31 of FIG. 4, the printing apparatus controller 25 starts the conveyance of the web W. Specifically, the printing apparatus controller 25 causes the conveyance motor 44 to start drive of the conveyance rollers 43 and also instructs the unwinder controller 13 and the rewinder controller 63 to start the conveyance of the web W. When the instruction to start the conveyance of the web W is given, the unwinder controller 13 causes the brake 12 to start output of braking force and the rewinder controller 63 causes the rewinding motor 62 to start drive of the rewinding shaft 61.

The unwinding and conveyance of the web W from the web roll 16 is thereby started. Application of the brake to the web roll support shaft 11 by the brake 12 causes the web W to be conveyed with tension applied to the web W between the web roll 16 and the pair of conveyance rollers 43. When the conveyance of the web K is starced, the output of the pulse signals from the encoders 22A, 22B is started in response to the start of rotation of the guide rollers 34, 36.

After the start of the conveyance of the web W, in step S2, the printing apparatus controller 25 determines whether the conveyance speed of the web W has reached a specified conveyance speed.

In this case, when the conveyance of the web W is started and then the conveyance speed of the web W is increased to the specified conveyance speed, the printing apparatus controller 25 performs conveyance control to transition to constant speed conveyance at the specified conveyance speed. For example, the specified conveyance speed is set to the same speed as the conveyance speed of the web W in printing (print conveyance speed).

When the printing apparatus controller 25 determines that the conveyance speed of the web W has not reached the specified conveyance speed (step S2: NO), the printing apparatus controller 25 repeats step S2. When the printing apparatus controller 25 determines that the conveyance speed of the web w has reached the specified conveyance speed (step S2: YES), in step S3, the printing apparatus controller 25 starts count of the output pulses of the encoders 22A, 22B.

Next, in step S4, the printing apparatus controller 25 determines whether a conveyance distance of the web W from the count start of the output pulses of the encoders 22A, 22B has reached a specified conveyance distance Lm. In this case, since the web W is subjected to the constant speed conveyance at the specified conveyance speed, the printing apparatus controller 25 can determine whether the conveyance distance of the web W has reached the specified conveyance distance Lm by using time elapsed from the count start of the output pulses of the encoders 22A, 22B.

The specified conveyance distance Lm is set in advance as a conveyance distance of the web W for measuring a difference in the number of output pulses between the encoders 22A, 22B due to the difference in the outer circumferential length between the guide rollers 34, 36. The specified conveyance distance Lm is set to a relatively long distance such as, for example, a distance corresponding to 20 rotations of the guide rollers 34, 36 to suppress an effect of errors in the numbers of output pulses of the encoders 22A, 22B on the measurement result.

When the printing apparatus controller 25 determines that the conveyance distance of the web W from the count start of the output pulses of the encoders 22A, 22B has not reached the specified conveyance distance Lm (step S4: NO), the printing apparatus controller 25 repeats step S4.

When the printing apparatus controller 25 determines that the conveyance distance of the web W from the count start of the output pulses of the encoders 22A, 22B has reached the specified conveyance distance Lm (step S4: YES), in step S5, the printing apparatus controller 25 terminates the count of the output pulses of the encoders 22A, 22B. A count value Ca of the output pulses of the encoder 22A and a count value Cb of the output pulses of the encoder 22B in the conveyance of the web W over the specified conveyance distance Lm are thereby obtained.

Next, in step S6, the printing apparatus controller 25 terminates the conveyance of the web W. Specifically, the printing apparatus controller 25 stops the conveyance motor 44 and instructs the unwinder controller 13 and the rewinder controller 63 to terminate the conveyance of the web K. When the instruction to terminate the conveyance of the web W is given, the unwinder controller 13 stops the brake 12 and the rewinder controller 63 stops the rewinding motor 62.

Next, in step S7, the printing apparatus controller 25 calculates a pulse difference Dm. The pulse difference lm is a difference in the number of output pulses between the encoders 22A, 22B for the specified conveyance distance Lm and is calculated by using the following formula (1).

Dm=|Ca−Cb| (1)

Next, in step S8, the printing apparatus controller 25 determines whether the pulse difference Dm is less than a threshold Dth. In this description, the threshold Dth is set as a value for determining whether the pulse difference Dm, being a value depending on the difference in the outer circumferential length between the guide rollers 34, 36, is so small that the print length can be adjusted with an effect on the print image suppressed.

When the printing apparatus controller 25 determines that the pulse difference Dm is less than the threshold Dth (step S8: YES), in step S9, the printing apparatus controller 25 calculates the pulse difference Db per page. Assuming that the length of one page in the conveyance direction of the web W is Ln, the pulse difference Db per page can be obtained by using the following formula (2).

Db=(Ln/Lm)×Dm (2)

In this case, the printing apparatus controller 25 calculates the pulse difference Db per page for each of the lengths Ln of one page in the respective page sizes printable in the printing apparatus 3.

Next, in step S10, the printing apparatus controller 25 calculates a difference sum (cumulative difference) Dsum(n). The difference sum Dsum(n) is a sum of the pulse differences Db per page from the first page to the n-th page. The calculation of the difference sum Dsum(n) is performed to a predetermined page calculation to which is considered to be sufficient for extraction of a cyclic pattern of an adjustment flag to be described later. The difference sum Dsum(n) is calculated by using the following formula (3).

Dsum(n)=Db×n (3)

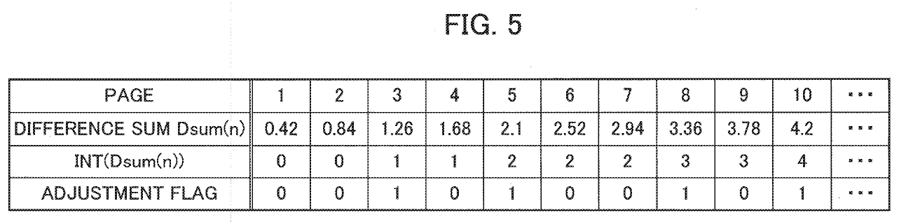

For example, when Lm=5000 mm, Ln=420 mm, Ca=21600, and Ca=21595, Dm=5 and Db=0.42. In this case, the difference sum Dsum(n) is calculated as illustrated in FIG. 5.

The printing apparatus controller 25 calculates the difference sum Dsum(n) from the calculated pulse difference Db per page, for each of the lengths Ln of one page in the respective page sizes printable in the printing apparatus 3.

Next, in step S11, the printing apparatus controller 25 rounds down the difference sum Dsum(n) to an integer. Specifically, the printing apparatus controller 25 calculates INT(Dsum(n)). The INT(Dsum(n)) indicates an integer portion of the difference sum Dsum(n). For example, the INT(Dsum(n)) is calculated as illustrated in FIG. 5.

The printing apparatus controller 25 rounds down the calculated difference sum Dsum(n) to an integer for each of the lengths Ln of one page in the respective page sizes printable in the printing apparatus 3.

Next, in step S12, the printing apparatus controller 25 generates the adjustment table 71 based on the value of the INT(Dsum(n)).

Specifically, first, as illustrated in the example of FIG. 5, the printing apparatus controller 25 sets adjustment flags for pages in which the INT(Dsum(n)) increases to “1” and sets adjustment flags for other pages to “0.”

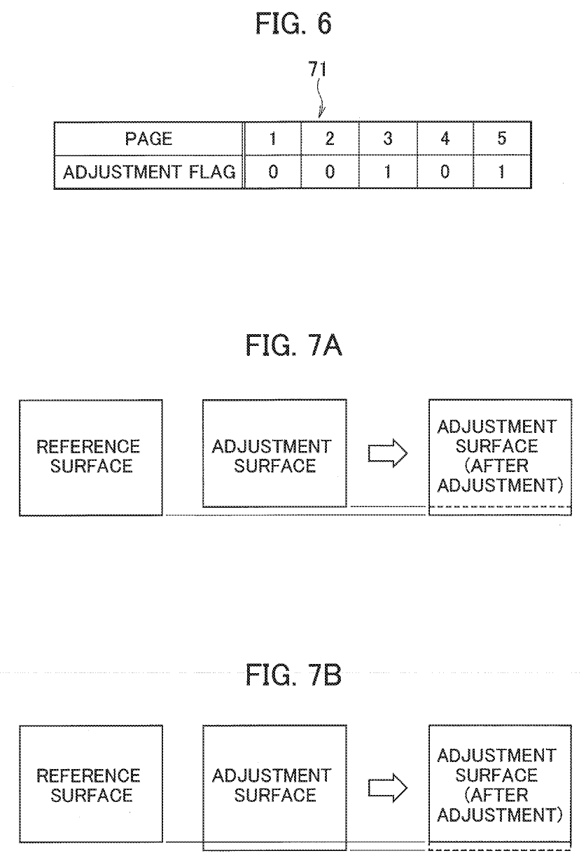

Then, the printing apparatus controller 25 generates the adjustment table 71 in which the pages and the adjustment flags are associated with one another as illustrated in FIG. 6 and stores the adjustment table 71. The adjustment flags “1” in the adjustment table 71 indicate that the corresponding pages are pages in which the adjustment of the print length is to be performed.

In this case, the printing apparatus controller 25 generates the adjustment table 71 by extracting a pattern of one cycle from the adjustment flags of the respective pages. In the example of FIG. 6, the adjustment table 71 holds the adjustment flags for one cycle including five pages. Even when the adjustment flags do not form an exact cyclic pattern, the printing apparatus controller 25 may extract a pattern of one cycle within a range which can be considered as a cyclic pattern. The adjustment of the print length in the printing on the web W is performed by repeatedly using the adjustment flags for one cycle in the adjustment table 71.

The printing apparatus controller 25 generates the adjustment table 71 based on the value of INT(Dsum(n)) for each of the lengths Ln of one page in the respective page sizes printable in the printing apparatus 3. In other words, the adjustment table 71 is generated for each of the lengths Ln of one page.

When the printing apparatus controller 25 generates and stores the adjustment table 71, the adjustment table generating operation is completed.

When the printing apparatus controller 25 determines that the pulse difference Dm is equal to or more than the threshold Dth in step S8 (step S8: NO), in step S13, the printing apparatus controller 25 displays a message warning a user of an abnormality on the operation panel 24. The adjustment table generating operation is thereby terminated.

In this example, the pulse difference Dm being equal to or more than the threshold Dth means that the difference in the outer circumferential length between the guide rollers 34, 36 is excessively large. Accordingly, the printing apparatus controller 25 displays a message or the like notifying the user that there is an abnormality in the guide rollers 34, 36 and replacement thereof is thus necessary, as warning on the operation panel 24.

When the guide rollers 34, 36 are replaced according to the warning, the aforementioned adjustment table generating operation is executed.

Next, operations in printing in the print system 1 are described.

When the print job is inputted, the printing apparatus controller 25 starts the conveyance of the web W. When the conveyance of the web W is started and then the conveyance speed of the web W is increased to the predetermined print conveyance speed, the printing apparatus controller 25 transitions to the constant speed conveyance at the print conveyance speed.

After the constant speed conveyance of the web W at the print conveyance speed is started, the printing apparatus controller 25 causes the printer 23A to start printing on the front surface of the web W. Thereafter, the printing apparatus controller 25 causes the printer 23B to start printing on the back surface of the web W. In this case, the printing apparatus controller 25 performs control based on the output pulse signal of the encoder 22B such that a start position of printing on the back surface of the web W by the printer 23B matches a start position of printing on the front surface by the printer 23A.

After the start of printing, the printing apparatus controller 25 controls ink ejection timings of the inkjet heads 56 in the printer 23A based on the output pulse signal of the encoder 22A such that landing positions of the inks of the respective colors in the sub-scanning direction match one another for each line of the image extending in the main scanning direction on the front surface of the web W. Moreover, the printing apparatus controller 25 controls ink ejection timings of the inkjet heads 56 in the printer 23B based on the output pulse signal of the encoder 22B such that landing positions of the inks of the respective colors in the sub-scanning direction match one another for each line of the image extending in the main scanning direction on the back surface of the web W.

During the printing, the printing apparatus controller 25 adjusts the print length in at least one of the printers 23A, 23B page by page by referring to the adjustment table 71. In this case, the printing apparatus controller 25 refers to the adjustment table 71 corresponding to the length Ln of one page in the print job being performed.

Specifically, for a page whose adjustment flag is “1” in the adjustment table 71, the printing apparatus controller 25 adjusts the print length of this page in at least one of the printers 23A, 23B.

An adjustment value for reducing the difference in the print length between the front and back surfaces in the adjustment of the print length is set to the number of lines per pulse of the output pulse signal of the encoder 22. The adjustment flag being “1” means that the number of lines per pulse of the output pulse signal of the encoder 22 is set as the adjustment value for the page corresponding to this adjustment flag. Moreover, the adjustment flag being “0” means that the adjustment value for the page corresponding to this adjustment flag is “0.”

The number of lines per pulse of the output pulse signal of the encoder 22 is the number of lines depending on a print resolution in the sub-scanning direction. For example, when the number of lines per pulse of the output pulse signal of the encoder 22 is “1,” the adjustment values is “1. ” Meanwhile, when the number of lines per pulse of the output pulse signal of the encoder 22 is “2,” the adjustment values is “2.” Since the adjustment value is a value calculated depending on the adjustment flag determined as described above, it can be said that the adjustment value is a value calculated by using the difference sum Dsum(n) which is the sum of the pulse differences Db per page of the respective pages.

The adjustment of the print length is achieved in at least one of the printers 23A, 23B by increasing or reducing the number of lines in the page with the adjustment flag of “1.”

For example, the printing apparatus controller 25 sets one of the front and back surfaces of the web W as a reference surface and the other one of the front and back surfaces as an adjustment surface and increases or decreases the number of lines by the adjustment value in the page with the adjustment flag of “1” in the printer 23 corresponding to the adjustment surface.

In this case, assume that the reference surface is the surface to be subjected to printing by the printer 23 corresponding to the encoder 22 in which the count value of the output pulses for the specified conveyance distance Lm of the web W measured in the aforementioned adjustment table generating operation is larger. In this case, as illustrated in FIG. 7A, in the page with the adjustment flag of “1,” the printing apparatus controller 25 adds as many lines as the adjustment value to a page image on the adjustment surface and controls the printer 23 corresponding to the adjustment surface such that the print length is extended by the adjustment value. Addition of as many lines as the adjustment value is performed by, for example, copying the last line as many times as the adjustment value.

Assume that, contrary to the aforementioned case, the reference surface is the surface to be subjected to printing by the printer 23 corresponding to the encoder 22 in which the count value of the output pulses for the specified conveyance distance Lm of the web W is smaller. In this case, as illustrated in FIG. 7B, in the page with the adjustment flag of “1,” the printing apparatus controller 25 deletes as many lines as the adjustment value from a page image on the adjustment surface and controls the printer 23 corresponding to the adjustment surface such that the print length is reduced by the adjustment value. In this case, for example, as many lines as the adjustment value are deleted from the last line.

The reference surface may not be fixed to a certain surface and instead be switched for each page with the adjustment flag of “1.” Moreover, when the adjustment value is 2 or more, the print lengths of each page in both of the printers 23A, 23B may be adjusted and made uniform without setting the reference surface.

When the printing based on the print job is completed, the printing apparatus controller 25 terminates the conveyance of the web W. The series of operation is thereby completed.

As described above, in the printing apparatus 3, the printing apparatus controller 25 controls the ink ejection timings in the printers 23A, 23B based on the output pulse signals of the encoders 22A, 22B. This can suppress misalignment of the ink landing positions between the inkjet heads 56 in both of the printers 23A, 23B. A decrease in print image quality can be thereby suppressed.

Moreover, the printing apparatus controller 25 adjusts the print length in at least one of the printers 23A, 23B by using difference information indicating the difference in the outer circumferential length of the guide rollers 34, 36 such that the difference in the print length between the front and back surfaces of the web W is reduced. This suppresses the difference in the print length of the image between the front and back surfaces of the web W due to the difference in the outer circumferential length between the guide rollers 34, 36. As a result, misalignment between the images printed on the front and back surfaces of the web W can be reduced.

Accordingly, the printing apparatus 3 can reduce the misalignment between the images printed on the front and back surfaces of the web W while suppressing the decrease in the print image quality.

Moreover, in the first embodiment, the printing apparatus controller 25 uses the pulse difference Db per page as the difference information. Specifically, the printing apparatus controller 25 generates the adjustment table 71 by using the difference sum Dsum (n) which is the sum of the pulse differences Db per page. Then, the printing apparatus controller 25 adjusts the print length page by page in at least one of the printers 23A, 23B based on the adjustment value of the print length for each page corresponding to the adjustment flag of the adjustment table 71.

Using the pulse difference Db per page due to the difference in the outer circumferential length between the guide rollers 34, 36 as the difference information enables highly-accurate adjustment of the print length to reduce the difference in the print length of the image between the front and back surfaces of the web W.

Next, description is given of a second embodiment partially changed from the first embodiment.

In the second embodiment, the printing apparatus controller 25 uses a difference time Δ(n) which is a value of a difference in the time required by the number of output pulses to reach a specified value K being the number of output pulses corresponding to one page between the encoders 22A, 22B, as the difference information indicating the difference in the outer circumferential length between the guide rollers 34, 36. The printing apparatus controller 25 calculates the difference time ΔT(n) for each page and calculates an adjustment value X(n) of the print length for the next page which is used to reduce the difference in the print length between the front and back surfaces, by using the calculated difference time ΔT (n). Then, the printing apparatus controller 25 adjusts the print length of the next page in one of the printers 23A, 23B based on the calculated adjustment value X(n).

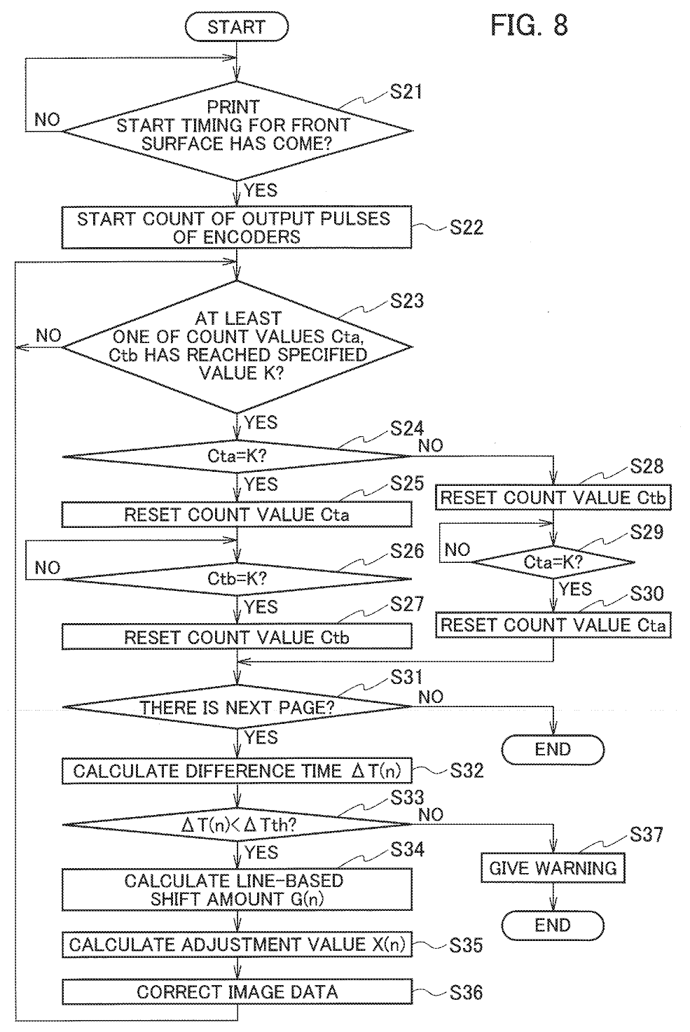

Next processing of adjusting the print length in the second embodiment is described with reference to the flowchart of FIG. 8.

In the processing of adjusting the print length, the printing apparatus controller 25 sets one of the front and back surfaces of the web W as the reference surface and the other one as the adjustment surface and adjusts the print length on the adjustment surface. Here, description is given of the case where the front surface is the reference surface.

The processing of the flowchart of FIG. 8 starts when the print job is inputted into the printing apparatus 3. In step S21 of FIG. 8, the printing apparatus controller 25 determines whether a print start timing for the front surface of the web W has come. In this case, the printing on the front surface of the web W starts after the conveyance of the web W is started and the conveyance speed of the web W reaches the print conveyance speed. When the printing apparatus controller 25 determines that the print start timing for the front surface has not come (step S21: NO), the printing apparatus controller 25 repeats step S21.

When the printing apparatus controller 25 determines that the print start timing for the front surface has come (step S21: YES), in step S22, the printing apparatus controller 25 starts counting the output pulses of the encoders 22A, 22B to adjust the print length.

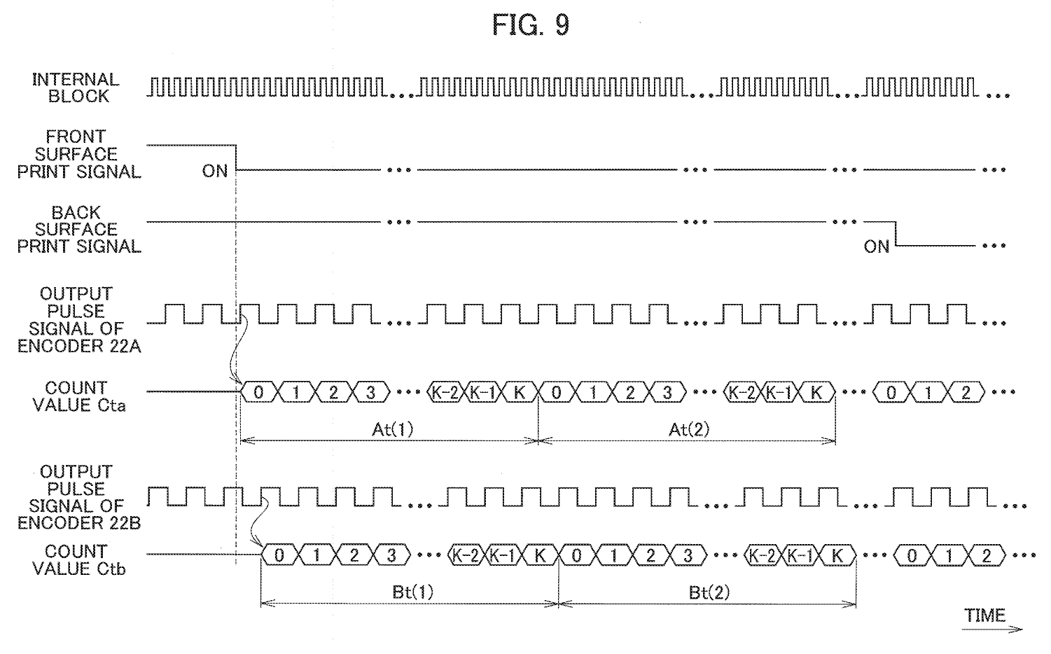

Specifically, as illustrated in FIG. 9, the printing apparatus controller 25 starts counting the output pulses of the encoders 22A, 22B to adjust the print length from a timing at which a front surface print signal turns on.

The front surface print signal and a back surface print signal in FIG. 9 are signals supplied to a FPGA controlling the ink ejection of the inkjet heads 56 in the printing apparatus controller 25. When the front surface print signal turns on, the printer 23A starts printing on the front surface of the web W. Meanwhile, when the back surface print signal turns on, the printer 23B starts printing on the back surface of the web W. The back surface print signal turns on at such a timing that a start position of the printing on the back surface of web W by the printer 23B matches a start position of the printing on the front surface by the printer 23A.

After the start of printing, the printing apparatus controller 25 controls the ink ejection timings of the inkjet heads 56 in the printer 23A based on the output pulse signal of the encoder 22A such that the landing positions of the inks of the respective colors in the sub-scanning direction match one another for each line of the image extending in the main scanning direction on the front surface of the web W. Moreover, the printing apparatus controller 25 controls the ink ejection timings of the inkjet heads 56 in the printer 23B based on the output pulse signal of the encoder 22B such that the landing positions of the inks of the respective colors in the sub-scanning direction match one another for each line of the image extending in the main scanning direction on the back surface of the web W.

Returning to FIG. 8, in step S23, the printing apparatus controller 25 determines whether at least one of count values Cta, Ctb of the output pulses of the encoders 22A, 22B counting for which has started in step S22 has reached the specified value K. When the printing apparatus controller 25 determines that neither of the count values Cta, Ctb has reached the specified value K (step S23: NO), the printing apparatus controller 25 repeats step S23.

When the printing apparatus controller 25 determines that at least one of the count values Cta, Ctb has reached the specified value K (step S23: YES), in step S24, the printing apparatus controller 25 determines whether the count value Cta has reached the specified value K.

When the printing apparatus controller 25 determines that the count value Cta has reached the specified value K (step S24: YES), in step S25, the printing apparatus controller 25 resets the count value Cta.

Next, in step S26, the printing apparatus controller 25 determines whether the count value Ctb has reached the specified value K. When the printing apparatus controller 25 determines that the count value Ctb has not reached the specified value K (step S26: NO), the printing apparatus controller 25 repeats step S26.

When the printing apparatus controller 25 determines that the count value Ctb has reached the specified value K (step S26: YES), in step S27, the printing apparatus controller 25 resets the count value Ctb. Then, the processing proceeds to step S31.

When the printing apparatus controller 25 determines that the count value Cta has not reached the specified value K, that is the count value Ctb has reached the specified value K in step S24 (step S24: NO), in step S28, the printing apparatus controller 25 resets the count value Ctb.

Next, in step S29, the printing apparatus controller 25 determines whether the count value Cta has reached the specified value K. When the printing apparatus controller 25 determines that the count value Cta has not reached the specified value K (step S29: NO), the printing apparatus controller 25 repeats step S29.

When the printing apparatus controller 25 determines that the count value Cta has reached the specified value K (step S29: YES), in step S30, the printing apparatus controller 25 resets the count value Cta. Then, the processing proceeds to step S31.

Each of the count values Cta, Ctb is reset when reaching the specified value K by the aforementioned processing of steps S23 to S30. When each of the count values Cta, Ctb is reset, the count thereof is started from zero.

In step S31, the priming apparatus controller 25 determines whether there is the next page to be printed in the print job. In this example, the next page is a page ((n+1)th page) subsequent to a page (n−th page) on the front surface of the web W corresponding to a count period (n-th count period) in which the count value Cta reached K this time.

When the printing apparatus controller 25 determines that there is a next page (step S31: YES), in step S32, the printing apparatus controller 25 calculates the difference time ΔT (n). The difference time ΔT (n) is calculated by using the following formula (4).

ΔT(n)=At(n)−Bt(n) (4)

In this formula, At (n) is a time required by the count value Cta to reach K from zero in the n−th count period of the output pulses of the encoder 22A. Moreover, Bt(n) is a time required by the count value Ctb to reach K from zero in the n−th count period of the output pulses of the encoder 22B. At (n) and Bt (n) are measured by using an internal clock of the FPGA included in the printing apparatus controller 25.

Note that, in the printing apparatus 3, the printers 23A, 23B are spaced away from each other in the sub-scanning direction. Accordingly, the timing of printing the corresponding pages is different between the front and back surfaces. Meanwhile, in the counting of the output pulses of the encoders 22A, 22B for the adjustment of the print length, it is only necessary to measure the difference time ΔT(n). Accordingly, the counting of the output pulses of the encoders 22A, 22B for the corresponding pages are performed simultaneously in parallel.

Next, in step S33, the printing apparatus controller 25 determines whether the difference time ΔT (n) is less than the threshold ΔTth. The threshold ΔTth is set as a value for determining whether the difference time ΔT(n), being a value depending on the difference in the outer circumferential length between the guide rollers 34, 36, is so small that the print length can be adjusted with an effect on the print image suppressed.

When the printing apparatus controller 25 determines that the difference time ΔT (n) is less than the threshold ΔTth (step S33: YES), in step S34, the printing apparatus controller 25 calculates a line-based shift amount G(n). The line-based shift amount G(n) indicates the difference in the print length between the front and back surfaces per page by the number of lines. The line-based shift amount G(n) is calculated by using the following formula (5).

G(n)=(ΔT(n)/T1)+Y(n−1) (5)

In this formula, T1 is a line cycle. The line cycle T1 is a print cycle of lines extending in the main scanning direction. The line cycle T1 is determined depending on the print resolution in the sub-scanning direction and the print conveyance speed. T(n)/T1 in the formula (5) corresponds to the number of lines printed in the difference time ΔT(n).

Y(n−1) is a fractional portion of a line-based shift amount G(n−1) corresponding to the previous ((n−1)th) count period.

Next, in step S35, the printing apparatus controller 25 calculates the adjustment value X(n). The adjustment value X(n) is an integer portion of the line-based shift amount G(n) and is expressed by the following formula (6).

X(n)=INT(G(n)) (6)

A fractional portion of the line-based shift amount G(n) is expressed by the following formula (7).

Y(n)−G(n)−INT(G(n)) (17)

The fractional portion Y(n) of the line-based shift amount G(n) is added to a line-based shift amount G(n+1) used for calculation of the next adjustment value X(n+1). Accordingly, as illustrated in the aforementioned formula (5), the line-based shift amount G(n) is an amount obtained by adding the fractional portion Y(n−1) of the previous line-based shift amount G(n−1) to T(n)/T1.

Carrying over the fractional portion Y(n) of the line-based shift amount Gin) to the calculation of the next adjustment value X(n+1) as described above prevents accumulation of errors between the line-based shift amount G(n) and the adjustment value X(n).

Next, in step S36, the printing apparatus controller 25 corrects the image data for the next page ((n+1) th page) on the adjustment surface based on the adjustment value X(n). In this example, since the back surface is the adjustment surface as described above, the printing apparatus controller 25 corrects the image data for the next page on the back surface.

Specifically, the printing apparatus controller 25 adjusts the number of lines in the image data for the next page on the back surface based on the adjustment value X(n). When the adjustment value X(n) is a positive value, the printing apparatus controller 25 adds as many lines as the adjustment value X(n) to the image data for the next page on the back surface. For example, addition of lines is performed by copying the last line. When the adjustment value X(n) is a negative value, the printing apparatus controller 25 deletes as many lines as the adjustment value X(n) from the image data for the next page on the back surface. For example, the printing apparatus controller 25 deletes as many lines as the adjustment value X(n) from the last line.

The print length on the adjustment surface are adjusted as illustrated in FIGS. 7A and 7B by performing printing based on the image data corrected as described above.

After step S36, the printing apparatus controller 25 returns to step S23 and repeats processing of step S23 and beyond.

When the printing apparatus controller 25 determines that there is no next page in step S31 (step S31: NO), the printing apparatus controller 25 terminates the series of processes.

When the printing apparatus controller 25 determines that the difference time ΔT(n) is equal to or more than the threshold ΔTth in step S33 (step S33: NO), in step S37, the printing apparatus controller 25 displays a message warning a user of an abnormality on the operation panel 24. Moreover, the printing apparatus controller 25 terminates the printing by the printers 23 and the conveyance of the web W. The series of processes is thereby terminated.

In this example, the difference time ΔT(n) being equal to or more than the threshold ΔTth means that the difference in the outer circumferential length between the guide rollers 34, 36 is excessively large. Accordingly, the printing apparatus controller 25 displays a message or the like notifying the user that there is an abnormality in the guide rollers 34, 36 and replacement thereof is thus necessary, as warning on the operation panel 24.

Also in the aforementioned second embodiment, as in the first embodiment, it is possible to reduce the misalignment between the images printed on the front and back surfaces of the web W while suppressing a decrease in the print image quality.

Moreover, in the second embodiment, the printing apparatus controller 25 uses the difference time ΔT (n) which is the difference value between the time required by the number of output pulses of the encoder 22A to reach the specified value K and the time required by the number of output pulses of the encoder 22B to reach the specified value K, as the difference information. The printing apparatus controller 25 calculates the difference time ΔT (n) for each page and calculates the adjustment value X(n) of the print length for the next page ((n+1)th page) which is used to reduce the difference in the print length between the front and back surfaces* by using the calculated difference time ΔT(n). Then, the printing apparatus controller 25 adjusts the print length of the next page in one of the printers 23A, 23B based on the calculated adjustment value X(n).

Using the difference time ΔT(n) due to the difference in the outer circumferential length between the guide rollers 34, 36 as the difference information can achieve highly-accurate adjustment of the print length to reduce the difference in the print length of the image between the front and back surfaces of the web W.

Moreover, the printing apparatus controller 25 calculates the line-based shift amount G(n) by using the difference time ΔT(n) and the line cycle T1 and calculates the integer portion of the line-based shift amount G(n) as the adjustment value X(n). Then, the printing apparatus controller 25 adds the fractional portion Y(n) of the line-based shift amount G(n) to the line-based shift amount G(n+1) used for the calculation of the next adjustment amount X(n+1). This prevents the accumulation of errors between the line-based shift amount G(n) and the adjustment amount X(n). Accordingly, the difference in the print length of the image between the front and back surfaces of the web W can be further suppressed.

Although the printing apparatus including the inkjet heads as the print mechanisms is described in the aforementioned first and second embodiments, the print mechanisms may be mechanisms using other methods such as an electrophotographic method.

Moreover, although the configuration in which the unwinder and the rewinder are connected to the printing apparatus as separate apparatuses is described in the aforementioned first and second embodiments, the configuration may be such that the unwinder and the rewinder are incorporated in the printing apparatus.

Furthermore, in the aforementioned second embodiment, one of the front and back surfaces of the web W is set as the reference surface while the other one is set as the adjustment surface, and the print length of the page on the adjustment surface printed by one of the printers 23A, 23B is adjusted. However, the print lengths can be made uniform by adjusting the print lengths of the pages in both of the printers 23A, 23B.

The first and second embodiments have, for example, the following configurations.

A printing apparatus includes: a first printer including first print mechanisms aligned in a conveyance direction of a web, the first printer configured to print a first image on a first surface of the web being conveyed by using the first print mechanisms; a second printer including second print mechanisms aligned in the conveyance direction, the second printer configured to print a second image on a second surface of the web being conveyed by using the second print mechanisms; a first roller configured to rotate in synchronization with the web being conveyed; a second roller configured to rotate in synchronization with the web being conveyed; a first encoder configured to output a first pulse signal depending on a rotation angle of the first roller; a second encoder configured to output a second pulse signal depending on a rotation angle of the second roller; and a controller configured to control first print timings in the respective first print mechanisms of the first printer based on the first pulse signal outputted from the first encoder and control second print timings in the respective second print mechanisms of the second printer based on the second pulse signal outputted from the second encoder.

The controller may be configured to adjust at least one of a first print length on the first surface or a second print length on the second surface in the conveyance direction by using difference information indicating a difference between a first outer circumferential length of the first roller and a second outer circumferential length of the second roller such that a difference between the first print length and the second print length is reduced.

The difference information may be a difference value between a number of first output pulses of the first encoder per page and a number of second output pulses of the second encoder per page. The controller may be configured to adjust at least one of the first print length or the second print length page by page based on an adjustment value of a print length for each of pages calculated by using a sum of the difference values at the page and used to reduce the difference between the first print length and the second print length.

The difference information may be a difference value between a first time required by a number of first output pulses of the first encoder to reach a number of output pulses corresponding to one page and a second time required by a number of second output pulses of the second encoder to reach a number of output pulses corresponding to one page. The controller may be configured to: calculate the difference value for each page; calculate an adjustment value of a print length for a next page used to reduce the difference between the first print length and the second print length, by using the calculated difference value; and adjust at least one of the first print length or the second print length of the next page based on the calculated adjustment value.

The controller may be configured to: calculate a line-based shift amount by using the calculated difference value, a print cycle of lines in the first image, and a print cycle of lines in the second image, the line-based shift, amount indicating the difference between the first print length and the second print length per page by a number of lines; calculate an integer portion of the calculated line-based shift amount as the adjustment value; adjust at least one of the first print length or the second print length of the next page by adjusting at least one of a number of lines in the first image or a number of lines in the second image based on the calculated adjustment value; and add a fractional portion of the calculated line-based shift amount to the line-based shift amount used in a next calculation of the adjustment value.

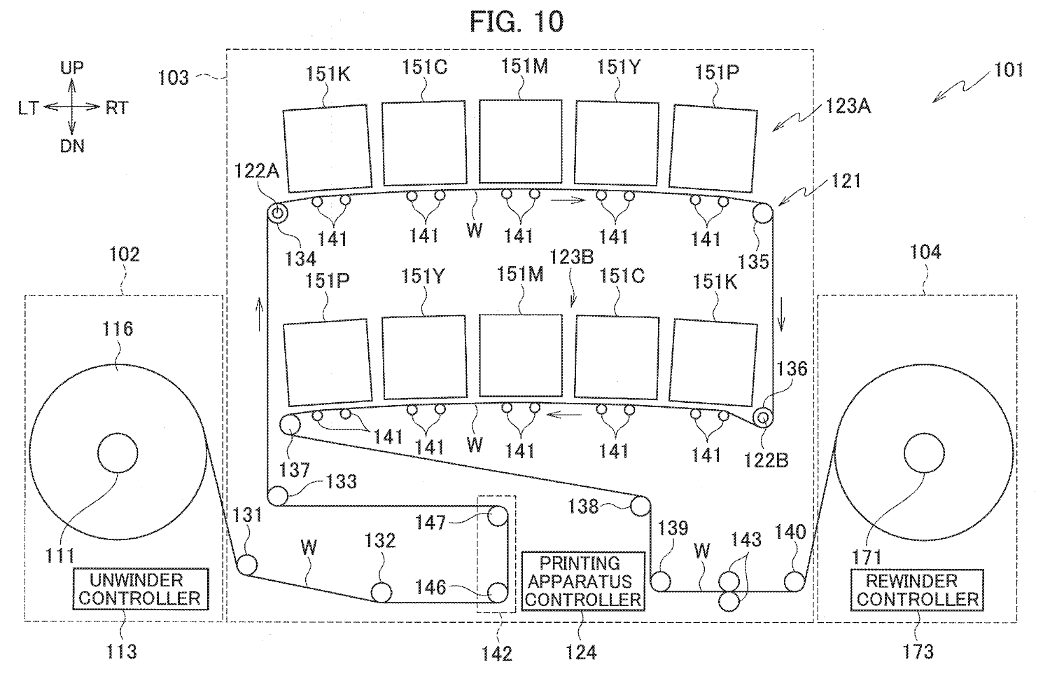

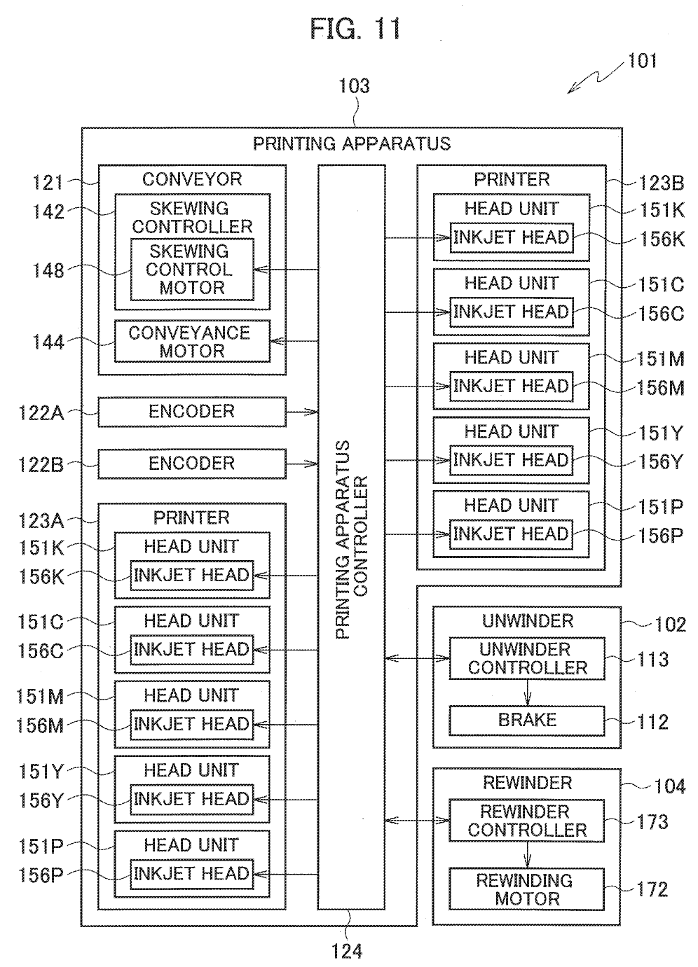

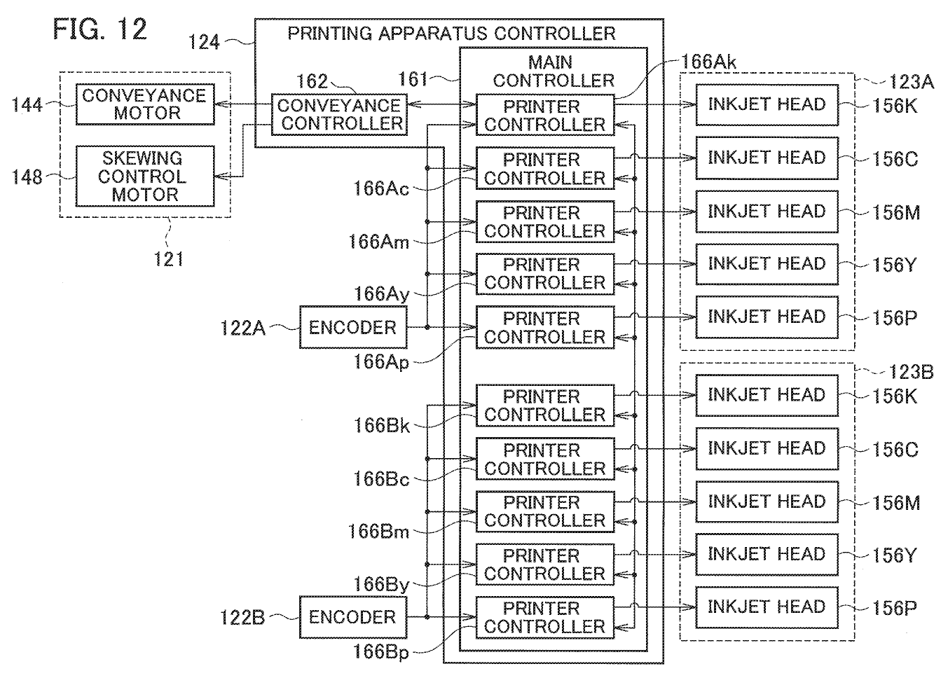

A third embodiment of the present invention is described with reference to the drawings. FIG. 10 is a schematic configuration view of a print system 101 including a printing apparatus 103 according to the third embodiment. FIG. 11 is a control block diagram of the print system 101 illustrated in FIG. 10. FIG. 12 is a block diagram illustrating a configuration of a printing apparatus controller 124 included in the printing apparatus 103 of the print system 101 illustrated in FIG. 10. In the following description, a direction orthogonal to the sheet surface of FIG. 10 is referred to as front-rear direction. Moreover, up, down, left, and right in the sheet surface of FIG. 10 are referred to as directions of up, down, left, and right. In FIG. 10, the directions of right, left, up, and down are denoted by RT, LT, UP, and DN.

As illustrated in FIGS. 10 and 11, the print system 101 according to the third embodiment includes an unwinder 102, the printing apparatus 103, and a rewinder 104.

The unwinder 102 unwinds a web W being a long print medium made of film, paper, or the like to the printing apparatus 103. The unwinder 102 includes a web roll support shaft 111, a brake 112, and an unwinder controller 113.

The web roll support shaft 111 rotatably supports a web roll 116. The web roll 116 is the web W wound into a roll.

The brake 112 applies brake to the web roll support shaft 111. Tension is thereby applied to the web W between the web roll 116 and a pair of conveyance rollers 143 of the printing apparatus 103 to be described later.

The unwinder controller 113 controls the brake 112. The unwinder controller 113 includes a CPU, a memory, a hard disk drive, and the like.

The printing apparatus 103 prints images on the web W while conveying the web W unwound from the web roll 116. The printing apparatus 103 includes a conveyor 121, an encoder 122A (first encoder), an encoder 122B (first encoder), a printer 123A (first printer), a printer 123B (second printer), and a printing apparatus controller (controller) 124. Note that members such as the encoders 122A, 122B maybe collectively referred to by omitting the alphabets attached to the reference numeral.

The conveyor 121 conveys the web W unwound from the web roll 116 to the rewinder 104. The conveyor 121 includes guide rollers 131 to 140, 20 under-head rollers 141, a skewing controller 142, the pair of conveyance rollers 143, and a conveyance motor 144.

The guide rollers 131 to 140 guide the web W conveyed in the printing apparatus 103. The guide rollers 131 to 140 rotate by following the web W being conveyed. The guide rollers 131 to 140, the under-head rollers 141, the conveyance rollers 143, and skewing control rollers 146, 147 of the skewing controller 142 to be described later form a conveyance route of the web W in the conveyor 121.

The guide rollers 131, 132 guide the web W between the unwinder 102 and the skewing controller 142. The guide roller 131 is arranged in a left end portion of a lower portion of the printing apparatus 103. The guide roller 132 is arranged between the guide roller 131 and the skewing control roller 146 of the skewing controller 142 to be described later.

The guide rollers 133 to 139 guide the web W between the skewing controller 142 and the pair of conveyance rollers 143. The guide roller 133 is arranged slightly above and on the left side of the skewing control roller 147 in the skewing controller 142 to be described later. The guide roller 134 is arranged above the guide roller 133. The guide roller 135 is arranged on the right side of the guide roller 134 at substantially the same height as the guide roller 134. The guide roller 136 is arranged below the guide roller 135 and above the guide roller 133. The guide roller 137 is arranged on the left side of the guide roller 136, near and on the right side of the web W between the guide rollers 133, 134, at substantially the same height as the guide roller 136. The guide roller 138 is arranged on the lower right side of the guide roller 137. The guide roller 139 is arranged below and slightly on the right side of the guide roller 138.

The guide roller 140 guides the web W between the pair of conveyance rollers 143 and the rewinder 104. The guide roller 140 is arranged in a right end portion of a lower portion of the printing apparatus 103.

The under-head rollers 141 support the web W under head units 151 to be described later in an area between the guide rollers 134, 135 and an area between the guide rollers 136, 137. Ten under-head rollers 141 are arranged in each of the area between the guide rollers 134, 135 and the area between the guide rollers 136, 137. Moreover, two under-head rollers 141 are arranged just below each head unit 151. The under-head rollers 141 rotate by following the web W being conveyed.

The skewing controller 142 corrects skewing which is fluctuation in the position of the web W in a width direction (front-rear direction) orthogonal to the conveyance direction of the web W. The skewing controller 142 includes the skewing control rollers 146, 147 and a skewing control motor 148.

The skewing control rollers 146, 147 are rollers for guiding the web W and correcting the skewing of the web W. The skewing control rollers 146, 147 rotate by following the web W being conveyed. The skewing control rollers 146, 147 move the web W in the width direction by being turned to tilt with respect to the width direction of the web W as viewed in the left-right direction and thereby correct the skewing. The skewing control roller 146 is arranged on the right side of the guide roller 132. The skewing control roller 147 is arranged above the skewing control roller 146.

The skewing control motor 148 turns the skewing control rollers 146, 147 about rotation axes parallel to the left-right direction.

The pair of conveyance rollers 143 conveys the web W toward the rewinder 104 while nipping the web W. The pair of conveyance rollers 143 is arranged between the guide rollers 139, 140.

The conveyance motor 144 rotationally drives the conveyance rollers 143.

An encoder 122A is installed in the guide roller 134 (first roller) and outputs a pulse signal depending on a rotation angle of the guide roller 134 which rotates by following (rotates in synchronization with) the web W being conveyed. An encoder 122B is installed in the guide roller 136 (second roller) and outputs a pulse signal depending on a rotation angle of the guide roller 136 which rotates by following (rotates in synchronization with) the web W being conveyed.

The guide rollers 134, 136 in which the encoders 122A, 122B are installed are turn rollers provided respectively at positions where the web W is made to curve near and upstream of the printers 123A, 123B in the conveyance direction of the web W.

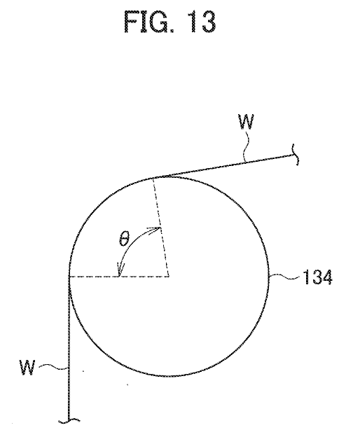

The turn rollers are rollers in which a holding angle of the web W is equal to or more than a specified angle. The specified angle of the holding angle is an angle set as a holding angle large enough to suppress sliding of the web W on the roller. The holding angle of the web W in each roller is an angle of a portion of the web W wound on the roller. For example, the holding angle of the web W on the guide roller 134 is 6 illustrated in FIG. 13.

The printer 123A prints images on a front surface (first surface) of the web W. The printer 123A is arranged near and above the web W between the guide rollers 134, 135. The printer 123A includes head units 151K, 151C, 151M, 151Y, 151P.

The head units 151K, 151C, 151M, 151Y, 151P include Inkjet heads (print mechanisms) 156K, 156C, 156M, 156Y, 156P, respectively. The head units 151K, 151C, 151M, 151Y, 151P are aligned in the conveyance direction of the web W. Accordingly, the inkjet heads 156K, 156C, 156M, 156Y, 156P are also aligned in the conveyance direction of the web W.

The inkjet heads 156K, 156C, 156M, 156Y, 156P print images by ejecting inks of black (K), cyan (C), magenta (M), yellow (Y), and an extra ink color, respectively, to the web W. Red, light cyan, or the like is used as the extra ink color.

The inkjet heads 156 each include multiple nozzles (not illustrated) which are arranged in the main scanning direction (front-rear direction) and which are opened on an ink ejection surface facing the web W and eject the inks from the nozzles.

The printer 123B prints images on a back surface (second surface) of the web W. The printer 123B is arranged near and above the web W between the guide rollers 136, 137. In other words, the printer 123B is arranged downstream of the printer 123A in the conveyance direction of the web W. The printer 123B includes head units 151K, 151C, 151M, 151Y, 151P, like the printer 123A.

The configuration of the printer 123B is right-left reversed to the configuration of the printer 123A. The configuration of the printer 123B is the same as that of the printer 123A except for being right-left reversed.

The printing apparatus controller 124 controls operations of the units in the printing apparatus 103. As illustrated in FIG. 12, the printing apparatus controller 124 includes a main controller 161 and a conveyance controller 162.

The main controller 161 is responsible for control of the entire printing apparatus 103. The main controller 161 includes printer controllers 166Ak, 166Ac, 166Am, 166Ay, 166Ap, 166Bk, 166Bc, 166Bm, 166By, 166Bp. Note that the printer controllers 166Ak, 166AC, 166Am, 166Ay, 166Ap, 166Bk, 166Bc, 166Bm, 166By, 166Bp each include a CPU, a memory, a hard disk drive, and the like.

The printer controllers 166Ak, 166Ac, 166Am, 166Ay, 166Ap control drive of the inkjet heads 156K, 156C, 156M, 156Y, 156P in the printer 123A, respectively. The printer controllers 166Ak, 166Ac, 166Am, 166Ay, 166Ap control ink ejection timings (print timings) in the Inkjet heads 156K, 156C, 156M, 156Y, 156P in the printer 123A, respectively, based on the output pulse signal of the encoder 122A which has been outputted since a conveyance start timing (control start timing) of the web W.

The printer controllers 166Bk, 166Bc, 166Bm, 166By, 166Bp control the drive of the inkjet heads 156K, 156C, 156M, 156Y, 156P in the printer 123B, respectively. The printer controllers 166Bk, 166Bc, 166Bm, 166By, 1663p control ink ejection timings in the inkjet heads 156K, 156C, 156M, 156Y, 156P in the printer 123B, respectively, based on the output pulse signal of the encoder 122B which has been outputted since the conveyance start timing of the web W.

The conveyance controller 162 controls conveyance of the web W by the conveyor 121. The conveyance controller 162 includes a CPU, a memory, and the like.

The rewinder 104 rewinds the web W subjected to printing in the printing apparatus 103. The rewinder 104 includes a rewinding shaft 171, a rewinding motor 172, and a rewinder controller 173.

The rewinding shaft 171 rewinds and holds the web W.

The rewinding motor 172 rotates the rewinding shaft 171 clockwise in FIG. 10. Rotation of the rewinding shaft 171 causes the web W to be rewound on the rewinding shaft 171.

The rewinder controller 173 controls drive of the rewinding motor 172. The rewinder controller 173 includes a CPU, a memory, a hard disk drive, and the like.

Next, operations of the print system 101 are described.

When printing is performed in the print system 101, each printer controller 166 in the printing apparatus controller 124 receives compressed image data of a target to be printed by the inkjet head 156 controlled by this printer controller 166, from an external apparatus. For example, the printer controller 166Ak receives compressed imagedata for causing the inkjet head 156K in the printer 123A to print an image with the black ink on the front surface of the web W.

When receiving the compressed image data, each printer controller 166 performs processing of decompressing the compressed image data.

Moreover, the printer controller 166Ak instructs the conveyance controller 162, the unwinder controller 113, and the rewinder controller 173 to start the conveyance of the web W and notifies the other printer controllers 166 of the start of the conveyance of the web W.

When the start of conveyance of the web W is instructed, the unwinder controller 113 causes the brake 112 to start output of brake force. Moreover, the conveyance controller 162 of the printing apparatus controller 124 causes the conveyance motor 144 to start the drive of the conveyance rollers 143. Furthermore, the rewinder controller 173 causes the rewinding motor 172 to start the drive of the rewinding shaft 171. Unwinding and conveyance of the web W from the web roll 116 is thereby started. Applying brace to the web roll support shaft 111 with the brake 112 causes the web W to be conveyed with tension applied to the web W between the web roll 116 and the pair of conveyance rollers 143.

When the conveyance of the web W is started, the encoders 122A, 122B start output of the pulse signals In response to the start of rotation of the guide rollers 134, 136. The output pulse signal of the encoder 122A is inputted into the printer controllers 166Ak, 166Ac, 166Am, 166Ay, 166Ap. Moreover, the output pulse signal of the encoder 122B is inputted into the printer controllers 166Bk, 166Bc, 166Bm, 166By, 166Bp.

Then, the printer controllers 166Ak, 166Ac, 166Am, 166Ay, 166Ap perform ink ejection timing control in the inkjet heads 156K, 156C, 156M, 156Y, 156P of the printer 123A, respectively, based on the output pulse signal of the encoder 122A. Moreover, the printer controllers 166Bk, 166Bc, 166Bm, 166By, 166Bp perform ink ejection timing control in the inkjet heads 156K, 156C, 156M, 156Y, 156P of the printer 123B, respectively, based on the output pulse signal of the encoder 122B.

Specifically, when the input of the pulse signal from the encoder 122A is started, the printer controllers 166Ak, 166Ac, 166Am, 166Ay, 166Ap start count of the output pulses of the encoder 122A. Moreover, when the input of the pulse signal from the encoder 1223 is started, the printer controllers 166Bk, 166Bc, 166Bm, 166By, 166Bp start count of the output pulses of the encoder 122B.

In each printer controller 166, when the count value of the output pulses from the corresponding encoder 122 reaches a print start count value set for the printer controller 166, the printer controller 166 starts ink ejection based on the image data by using the inkjet head 156 corresponding to the printer controller 166.

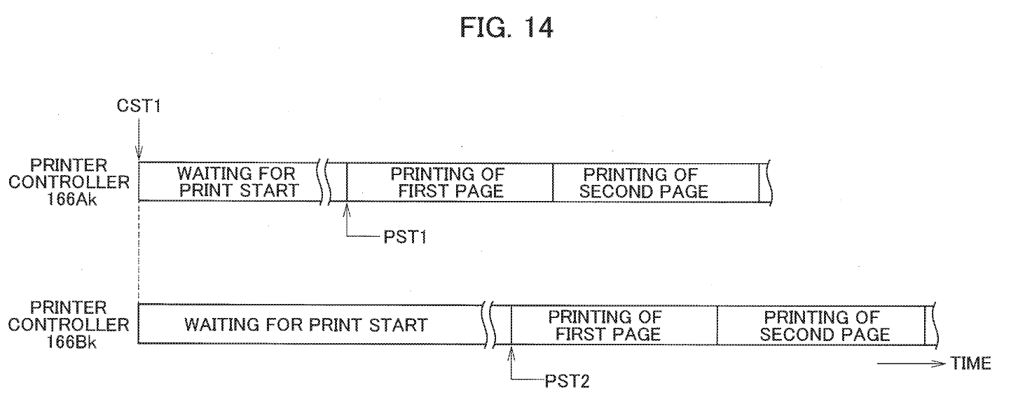

Specifically, for example, when a conveyance start timing CST1 of the web W comes as illustrated in an upper section of FIG. 14, the printer controller 166Ak starts the count of the output pulses of the encoder 122A. Then, when the count value of the output pulses of the encoder 122A which have been outputted since the conveyance start timing CTS1 of the web W reaches the print start count value set for the printer controller 166Ak (timing PST1), the printer controller 166Ak starts printing with the inkjet head 156K of the printer 123A. Specifically, the printer controller 166Ak causes the inkjet head 156K of the printer 123A to start ink ejection based on the image data for printing with the black ink on the front surface of the web W. The printer controller 166Ak controls the timing of ink ejection performed based on the image data by the inkjet head 156K of the printer 123A, based on the output pulse signal of the encoder 122A and executes printing of each page.

When the conveyance of the web W is started, the web W is accelerated at predetermined acceleration until the conveyance speed reaches a predetermined print conveyance speed. After the conveyance speed of the web W reaches the print conveyance speed, the constant speed conveyance is performed at the print conveyance speed. The printing on the web W is performed after the start of the constant speed conveyance of the web W at the print conveyance speed.

The print start count value for the printer controller 166Ak is set such that the printing with the inkjet head 156K starts after the start of the constant speed conveyance of the web W. A period until the moment when the count value of the output pulses of the encoder 122A reaches the print start count value for the printer controller 166Ak is a print start wait period in the Inkjet head 156K.

Moreover, like the printer controller 166Ak, the printer controllers 166Ac, 166Am, 166Ay, 166Ap also start the printing with the inkjet heads 156C, 156M, 156Y, 156P of the printer 123A, respectively, when the count value of the output pulses of the encoder 122A which have been outputted since the conveyance start timing of the web K reaches the print start count values set for the respective printer controllers 166. The printer controllers 166Ac, 166Am, 166Ay, 166Ap control the timings of ink ejection performed based on the image data by the inkjet heads 156C, 156M, 156Y, 156P of the printer 123A, respectively, based on the output pulse signal of the encoder 122A and execute printing of each page.

The print start count value for the printer controller 166Ac is greater than the print start count value for the printer controller 166Ak by an amount corresponding to the distance (distance along the conveyance route) between the Inkjet heads 156K, 156C in the printer 123A. Similarly, the print start count values for the printer controllers 166Am, 166Ay, 166Ap are set to increase in increments corresponding to the distance between the inkjet heads 156C, 156M, the distance between the inkjet heads 156M, 156Y, and the distance between the inkjet heads 156Y, 156P, respectively. This allows the inks of the respective colors to land in the same pixel in an overlaid manner.

Moreover, for example, when a conveyance start timing CST2 of the web W comes as illustrated in a lower section of FIG. 14, the printer controller 166Bk starts the count of the output pulses of the encoder 122B. Then, when the count value of the output pulses of the encoder 122B which have been outputted since the conveyance start timing CTS2 of the web W reaches the print start court value set for the printer controller 166Bk (timing PST2), the printer controller 166Bk starts printing with the inkjet head 156K of the printer 123B. Specifically, the printer controller 166Bk causes the inkjet head 156K of the printer 123B to start ink ejection based on the image data for printing with the black ink on the back surface of the web W. The printer controller 166Bk controls the timing of ink ejection performed based on the image data by the inkjet head 156K of the printer 123B, based on the output pulse signal of the encoder 122B and executes printing of each page.

The print start count value for the printer controller 166Bk is greater than the print start count value for the printer controller 166Ap by an amount corresponding to the distance (distance along the conveyance route) between the inkjet head 156P in the printer 123A and the inkjet head 156K in the printer 123B. In other words, the print start count value for the printer controller 166Bk is greater than the print start count value for the printer controller 166Ak by an amount corresponding to the distance between the inkjet head 156K in the printer 123A and the inkjet head 156K in the printer 123B.

Moreover, like the printer controller 166Bk, the printer controllers 166Bc, 166Bm, 166By, 166Bp also start the printing with the inkjet heads 156C, 156M, 156Y, 156P of the printer 123B, respectively, when the count value of the output pulses of the encoder 122B which have been outputted since the conveyance start timing of the web W reaches the print start count values set for the respective printer controllers 166. The printer controllers 166Bc, 166Bm, 166By, 166Bp control the timings of ink ejection performed based on the image data by the inkjet heads 156C, 156M, 156Y, 156P of the printer 123B, respectively, based on the output pulse signal of the encoder 122B and executes printing of each page.

The print start count value for the printer controller 166Bc is greater than the print start count value for the printer controller 166Bk by an amount corresponding to the distance between the inkjet heads 156K, 156C in the printer 123B. Similarly, the print start count values for the printer controllers 166Bm, 166By, 166Bp are set to increase in increments corresponding to the distance between the inkjet heads 156C, 156M, the distance between the inkjet heads 156M, 156Y, and the distance between the inkjet heads 156Y, 156P, respectively.

When the printing performed based on the image data by the inkjet heads 156 of the printers 123A, 123B is completed, the printer controller 166Ak instructs the conveyance controller 162, the unwinder controller 113, and the rewinder controller 173 to terminate the conveyance of the web W.

When the termination of the conveyance of the web W is instructed, the conveyance controller 162 stops the conveyance motor 144, the unwinder controller 113 stops the brake 122, and the rewinder controller 173 steps the rewinder motor 172. The conveyance of the web W is thereby terminated and the series of operations is completed.

As described above, in the printing apparatus 103, the printing apparatus controller 124 controls the ink ejection timings in the inkjet heads 156 of the printer 123A based on the output pulse signal of the encoder 122A which has been outputted since the conveyance start timing of the web W. Moreover, the printing apparatus controller 124 controls the ink ejection timings in the inkjet heads 156 of the printer 123B based on the output pulse signal of the encoder 1223 which has been outputted since the conveyance start timing of the web W.

Controlling the ink ejection timings in the printers 123A, 123B by using the encoders 122A, 122B arranged near the respective printers 123A, 123B as described above suppresses misalignment of the ink landing positions between the inkjet heads 156 in both of the printers 123A, 123B. A decrease in print image quality is thereby suppressed.

Assume a case where no encoder 122B is provided and the ink ejection timings in the printers 123A, 123B are controlled by using only the encoder 122A unlike in the third embodiment. In this case, the printer 123B is far away from the encoder 122A. Accordingly, the output pulse signal of the encoder 122A is more likely to deviate from the actual movement of the web W at the position of the printer 123B. Thus, in the printer 123B, misalignment of ink landing positions between the ink jet heads 156 may occur due to a decrease in ink landing accuracy.

Moreover, in this case, the presence of the guide rollers 135, 136, being the turn rollers, between the encoder 122A and the printer 123B is also a factor which causes the misalignment of the ink landing positions between the inkjet heads 156 in the printer 123B. Specifically, the turn rollers have large roller diameters because high strength is required for the turn rollers. Accordingly, the mechanical tolerance for the roundness of these rollers greatly affects tension fluctuation (speed fluctuation) in the web W. The output pulse signal of the encoder 122A is thus more likely to deviate from the actual movement of the web W at the position of the printer 123B. As a result, the misalignment of ink landing positions between the inkjet heads 156 is more likely to occur in the printer 123B.

Meanwhile, in the third embodiment, the misalignment of the ink landing positions between the inkjet heads 156 in both of the printers 123A, 123B can be suppressed by using the encoders 122A, 122B arranged near the printers 123A, 123B, respectively, as described above.

A printing apparatus for a web as follows is conceivable. A sensor arranged near and upstream of each of a printer for a front surface and a printer for a back surface detects a mark provided on the web as a sign. Ink ejection timings of inkjet heads in each of the printers for the front and back surfaces are controlled based on an output pulse signal of an encoder corresponding to the printer with a timing at which the sensor corresponding to the printer detects the mark used as a reference. However, in the method in which the ink ejection timings in each of the printers for the front and back surfaces are controlled by using the encoder corresponding to the printer with the timing at which the sensor detects the mark used as the reference, a mechanism for providing the mark and the sensor for detecting the mark need to be provided and the configuration of the printing apparatus is complex.

Meanwhile, in the printing apparatus 103 of the third embodiment, the control of the printers 123A, 123B is performed based on the output signals of the encoders 122A, 122B which have been outputted since the same control start timing (conveyance start timing of the web W). Accordingly, a mark on the web W used as a sign for starting the count of the output pulses of the encoder 122A, 122B for each of the printers 123A, 123B is unnecessary. Thus, the mechanism for providing the mark and the sensor for detecting the mark are unnecessary and the configuration of the printing apparatus can be prevented from becoming complex.

Hence, the printing apparatus 103 can reduce the decrease in print image quality while preventing the printing apparatus from becoming complex.

Moreover, the encoders 122A, 122B are installed in the guide rollers 134, 136 which are the turn rollers provided respectively at positions where the web W is made to curve. Specifically, the encoders 122A, 122B are installed in the guide rollers 134, 136 which are the turn rollers where slipping of the web W is less likely to occur. Accordingly, the case where the output pulse signal deviates from the actual movement of the web W is less likely to occur. This suppresses the decrease in ink landing position accuracy in the printers 123A, 123B. Thus, the decrease in print image quality can be further reduced.

Note that, although one encoder 122 is installed for each printer 123 in the aforementioned third embodiment, multiple encoders 122 installed respectively in different rollers may be arranged for each printer 123.

For example, the encoder 122 for the printer 123A may be installed also in the guide roller 135. In this case, for example, the encoder 122A installed in the guide roller 134 is used for the control of the inkjet heads 156K, 156C of the printer 123A and the encoder 122 installed in the guider roller 135 is used for the control of the inkjet heads 156M, 156Y, 156P. Moreover, for example, the encoder 122 for the printer 123B may be installed also in the guide roller 137. In this case, for example, the encoder 122B installed in the guide roller 136 is used for the control of the Inkjet heads 156K, 156C of the printer 123B and the encoder 122 installed in the guider roller 137 is used for the control of the inkjet heads 156M, 156Y, 156P. When multiple encoders 122 are provided for each printer 123, at least one inkjet head 156 corresponds to each encoder 122 and each of the encoders 122 is used for the control of the inkjet head 156 corresponding to this encoder 122.

Furthermore the rollers in which the encoders 122 are installed may be rollers which are not turn rollers. For example, the configuration may be such that rollers which rotate by following the web W are provided in the middle of the printers 123, specifically, between the guide rollers 134, 135 and between the guide rollers 136, 137 and the encoders 122 are installed in these rollers. This roller (first roller) in which the encoder 122 for the printer 123A is installed only has to be a roller provided near or in the middle of the printer 123A, upstream of the printer 123B. Moreover, the roller (second roller) in which the encoder 122 for the printer 123B is installed only has to be a roller provided near or in the middle of the printer 123B, downstream of the printer 123A and downstream of the most downstream roller provided with the encoder 122 for the printer 123A.

Moreover, when multiple encoders 122 are provided for each printer 123 and an abnormality is detected in the output pulse signal of any of the encoders 122, the control of the ink ejection timings in the inkjet heads 156 only needs to be performed by using at least one of the encoders 122 other than the encoder 122 in which the abnormality of the output pulse signal is detected.

For example, assume that the encoders 122 used to control the ink ejection timings in the inkjet heads 156 of the printer 123A include two encoders of the encoder 122A installed in the guider roller 134 and the encoder 122 installed in the guide roller 135. Moreover, the encoder 122A installed in the guide roller 134 is provided for the inkjet heads 156K, 156C of the printer 123A and the encoder 122 installed in the guide roller 135 is provided for the inkjet heads 156M, 156Y, 156P.

In this case, for example, assume that an abnormality is detected in the output pulse signal of the encoder 122 installed in the guide roller 135. In this case, it is only necessary to control the ink ejection timings in all of the inkjet heads 156K, 156C, 156M, 156Y, 156P of the printer 123A by using the encoder 122A installed in the guide roller 134 in which there is no abnormality of the output pulse signal.

Moreover, for example, assume that the encoders 122 used to control the ink ejection timings in the inkjet heads 156 of the printer 123B include two encoders of the encoder 122B installed in the guider roller 136 and the encoder 122 installed in the guide roller 137. Moreover, the encoder 122B installed in the guide roller 136 is provided for the inkjet heads 156K, 156C of the printer 123B and the encoder 122 installed in the guide roller 137 is provided for the inkjet heads 156M, 156Y, 156P.

In this case, for example, assume that an abnormality is detected in the output pulse signal of the encoder 122 installed in the guide roller 137. In this case, it is only necessary to control the ink ejection timings in all of the inkjet heads 156K, 156C, 156M, 156Y, 156P of the printer 123B by using the encoder 122B installed in the guide roller 136 in which there is no abnormality of the output pulse signal.

Even when there is an abnormality in the output pulse signal of any of the multiple encoders 122 for each printer 123, this configuration can suppress the decrease in the ink landing accuracy by excluding the encoder 122 with the abnormality and using the other encoder 122.

Examples of the abnormality in the output pulse signal of the encoder 122 include disturbance of the pulse cycle and the like. Such an abnormality in the output pulse signal of the encoder 122 is caused by, for example, the roller in which the encoder 122 is installed being greatly off-centered, occurrence of slipping of the web W on the roller in which the encoder 122 is installed, and the like.

Moreover, although the conveyance start timing of the web W is set as the control start timing of the ink ejection performed based on the output pulse signals of the encoders 122A, 122B in the aforementioned third embodiment, the control start timing is not limited to this. For example, a timing at which the conveyance speed of the web W reaches the print conveyance speed may be set as the control start timing of the ink ejection performed based on the output pulse signals of the encoders 122A, 122B.

Furthermore, although the printing apparatus including the inkjet heads as the print mechanisms is described in the aforementioned third embodiment, the print mechanisms may be mechanisms using other methods such as an electrophotographic method.

Moreover, although the configuration in which the unwinder and the rewinder are connected to the printing apparatus as separate apparatuses is described in the aforementioned third embodiment, the configuration may be such that the unwinder and the rewinder are incorporated in the printing apparatus.

The third embodiment has, for example, the following configurations.

A printing apparatus includes: a first printer including first print mechanisms aligned in a conveyance direction of a web, the first printer configured to print a first image on a first surface of the web being conveyed by using the first print mechanisms; a second printer including second print mechanisms aligned in the conveyance direction, the second printer configured to print a second image on a second surface of the web being conveyed by using the second print mechanisms; a first roller configured to rotate in synchronization with the web being conveyed; a second roller configured to rotate in synchronization with the web being conveyed; a first encoder configured to output a first pulse signal depending on a rotation angle of the first roller; a second encoder configured to output a second pulse signal depending on a rotation angle of the second roller; and a controller configured to control first print timings in the respective first print mechanisms of the first printer based on the first pulse signal outputted from the first encoder and control second print timings in the respective second print mechanisms of the second printer based on the second pulse signal outputted from the second encoder.

The second printer may be arranged downstream of the first printer in the conveyance direction, the first roller may be arranged upstream of the second printer in the conveyance direction, the second roller may be arranged downstream of the first printer and downstream of the first roller in the conveyance direction, the first encoder may be installed in the first roller, and the second encoder may be installed in the second roller. The controller may be configured to: control the first print timings based on the first pulse signal having been outputted since a control start timing; and control the second print timings based on the second pulse signal having been outputted since the control start timing.

At least one of the first roller or the second roller may be a turn roller provided at a position where the web curves.

The first roller may include two first rollers and the first encoder may include two first encoders installed in the two first rollers respectively. The controller may be configured to: control the first print timing in at least one of the first print mechanisms based on the first pulse signal outputted from one of the two first encoders; control the first print timing in the rest of the first print mechanisms based on the first pulse signal outputted from the other one of the two first encoders; and upon detection of an abnormality in the first pulse signal outputted from the one first encoder, control the first print timings in the respective first print mechanisms based on the first pulse signal outputted from the other first encoder.

The second roller may include two second rollers and the second encoder may include two second encoders installed in the two second rollers respectively. The controller may be configured to: control the second print timing in at least one of the second print mechanisms based on the second pulse signal outputted from one of the two second encoders; control the second print timing in the rest of the second print mechanisms based on the second pulse signal outputted from the other one of the two second encoders; and upon detection of an abnormality in the second pulse signal outputted from the one second encoder, control the second print timings in the respective second print mechanisms based on the second pulse signal outputted from the other second encoder.

The first roller may include at least two first rollers and the second roller may include at least two second rollers arranged downstream of a most-downstream one of the at least two first rollers in the conveyance direction. The first encoder may include at least two first encoders installed in the at least two first rollers respectively and configured to output first pulse signals depending on rotation angles of the at least two first rollers in which the first encoders are installed. The second encoder may include at least two second encoders installed in the at least two second rollers respectively and configured to output second pulse signals depending on rotation angles of the at least two second rollers in which the second encoders are installed. The controller may be configured to: control the first print timings based on the first pulse signal having been outputted from at least one of the at least two first encoders since the control start timing; and control the second print timings based on the second pulse signal having been outputted from at least one of the at least two second encoders since the control start timing.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A printing apparatus comprising:
a first printer including first print mechanisms aligned in a conveyance direction of a web/ the first printer configured to print a first image on a first surface of the web being conveyed by using the first print mechanisms;
a second printer including second print mechanisms aligned in the conveyance direction, the second printer configured to print a second image on a second surface of the web being conveyed by using the second print mechanisms;
a first roller configured to rotate in synchronization with the web being conveyed;
a second roller configured to rotate in synchronization with the web being conveyed;
a first encoder configured to output a first pulse signal depending on a rotation angle of the first roller;
a second encoder configured to output a second pulse signal depending on a rotation angle of the second roller; and
a controller configured to control first print timings in the respective first print mechanisms of the first printer based on the first pulse signal outputted from the first encoder and control second print timings in the respective second print mechanisms of the second printer based on the second pulse signal outputted from the second encoder.

2. The printing apparatus according to claim 1, wherein the controller is configured to adjust at least one of a first print length on the first surface or a second print length on the second surface in the conveyance direction by using difference information indicating a difference between a first outer circumferential length of the first roller and a second outer circumferential length of the second roller such that a difference between the first print length and the second print length is reduced.

3. The printing apparatus according to claim 2, wherein
the difference information is a difference value between a number of first output pulses of the first encoder per page and a number of second output pulses of the second encoder per page, and
the controller is configured to adjust at least one of the first print length or the second print length page by page based on an adjustment value of a print length for each of pages calculated by using a sum of the difference values at the page and used to reduce the difference between the first print length and the second print length.

4. The printing apparatus according to claim 2, wherein
the difference information is a difference value between a first time required by a number of first output pulses of the first encoder to reach a number of output pulses corresponding to one page and a second time required by a number of second output pulses of the second encoder to reach a number of output pulses corresponding to one page, and
the controller is configured to:
calculate the difference value for each page;
calculate an adjustment value of a print length for a next page used to reduce the difference between the first print length and the second print length, by using the calculated difference value; and
adjust at least one of the first print length or the second print length of the next page based on the calculated adjustment value.

5. The printing apparatus according to claim 4, wherein the controller is configured to:
calculate a line-based shift amount by using the calculated difference value, a print cycle of lines in the first image, and a print cycle of lines in the second image, the line-based shift amount indicating the difference between the first print length and the second print length per page by a number of lines;
calculate an integer portion of the calculated line-based shift amount as the adjustment value;
adjust at least one of the first print length or the second print length of the next page by adjusting at least one of a number of lines in the first image or a number of lines in the second image based on the calculated adjustment value; and
add a fractional portion of the calculated line-based shift amount to the line-based shift amount used in a next calculation of the adjustment value.

6. The printing apparatus according to claim 1, wherein
the second printer is arranged downstream of the first printer in the conveyance direction,
the first roller is arranged upstream of the second printer in the conveyance direction,
the second roller is arranged downstream of the first printer and downstream of the first roller in the conveyance direction,
the first encoder is installed in the first roller,
the second encoder is installed in the second roller, and
the controller is configured to:
control the first print timings based on the first pulse signal having been outputted since a control start timing; and
control the second print timings based on the second pulse signal having been outputted since the control start timing.

7. The printing apparatus according to claim 6, wherein at least one of the first roller or the second roller is a turn roller provided at a position where the web curves.

8. The printing apparatus according to claim 6, wherein
the first roller includes two first rollers,
the first encoder includes two first encoders installed in the two first rollers respectively, and
the controller is configured to:
control the first print timing in at least one of the first print mechanisms based on the first pulse signal outputted from one of the two first encoders;
control the first print timing in the rest of the first print mechanisms based on the first pulse signal outputted from the other one of the two first encoders; and
upon detection of an abnormality in the first pulse signal outputted from the one first encoder, control the first print timings in the respective first print mechanisms based on the first pulse signal outputted from the other first encoder.

9. The printing apparatus according to claim 6, wherein
the second roller includes two second rollers/
the second encoder includes two second encoders installed in the two second rollers respectively, and
the controller is configured to:
control the second print timing in at least one of the second print mechanisms based on the second pulse signal outputted from one of the two second encoders;
control the second print timing in the rest of the second print mechanisms based on the second pulse signal outputted from the other one of the two second encoders; and
upon detection of an abnormality in the second pulse signal outputted from the one second encoder, control the second print timings in the respective second print mechanisms based on the second pulse signal outputted from the other second encoder.

10. The printing apparatus according to claim 6, wherein
the first roller includes at least two first rollers,
the second roller includes at least two second rollers arranged downstream of a most-downstream one of the at least two first rollers in the conveyance direction,
the first encoder includes at least two first encoders installed in the at least two first rollers respectively and configured to output first pulse signals depending on rotation angles of the at least two first rollers in which the first encoders are installed,
the second encoder includes at least two second encoders installed in the at least two second rollers respectively and configured to output second pulse signals depending on rotation angles of the at least two second rollers in which the second encoders are installed, and
the controller is configured to:
control the first print timings based on the first pulse signal having been outputted from at least one of the at least two first encoders since the control start timing; and
control the second print timings based on the second pulse signal having been outputted from at least one of the at least two second encoders since the control start timing.
